(19) United States
(12) Patent Application Publication
(10) Pub. No.: US 2014/0344343 A1
(43) Pub. Date: Nov. 20, 2014

(54) METHOD AND SYSTEM FOR PRIVATE DISTRIBUTED COLLABORATIVE FILTERING

(71) Applicant: ICELERO LLC, San Jose, CA (US)

(72) Inventors: Amir Masoud Zarkesh, Saratoga, CA (US); Amit Ramchandran, San Jose, CA (US); Saeid Ghafouri, Saratoga, CA (US)

(73) Assignee: ICELERO LLC, San Jose, CA (US)

(21) Appl. No.: 14/357,610

(22) PCT Filed: Nov. 14, 2012
(86) PCT No.: PCT/US12/65020

§ 371 Date: May 12, 2014

Related U.S. Application Data
(60) Provisional application No. 61/560,263, filed on Nov. 15, 2011.

(51) Int. Cl. H04L 29/06

(52) U.S. Cl. CPC H04L 63/0227
USPC 709/203

(57) ABSTRACT

A system, method and computer program product for collaborative filtering, including a client device configured with distributed internal collaborative filtering mechanism and a user profile having private information of a user of the client device. The client device is configured to maintain the user profile securely within the client device. The client device is configured to calculate a set of non-private parameters based on the secure user profile with a process that runs on the client device. The client device is configured to send the non-private parameters to at least one of an external server and external client device.

### CROSS REFERENCE TO RELATED DOCUMENTS

The present invention claims benefit of priority to U.S. Provisional Patent Application Ser. No. 61/560,263 of Amir Masoud ZARKESH et al., entitled “A PROCESS FOR REAL PRIVATE DISTRIBUTED COLLABORATIVE FILTERING,” filed on Nov. 15, 2011, the entire disclosure of which is hereby incorporated by reference herein.

### BACKGROUND OF THE INVENTION

1. Field of the Invention

The present invention generally relates to systems and methods for collaborative filtering, and more particularly to systems and methods for private, distributed collaborative filtering, and the like.

2. Discussion of the Background

In recent years, personalization of various Internet services has become a crucial value to consumers and one of the main drivers for higher revenue for Internet companies, and the like. Progress has been made by employing collaborative filtering, for example, using a history of Internet browsing, and other activities, such as game, chat, emails, etc, to determine needs, wants, and the like, of a targeted consumer. However, such collaborative filtering systems and methods usually require sending of users' activity history to servers such that the privacy of consumer can be compromised. Moreover, extensive server based collaborative filtering is not scalable, since the size of personal history files, and hence the necessary bandwidth usage can increase significantly, while real-time collaborative filtering is limited by latency of communications between the client and the server. Accordingly, consumers may stop or limit the use of such server based collaborative filtering.

### SUMMARY OF THE INVENTION

Therefore, there is a need for methods and systems that address the above and other problems with collaborative filtering systems and methods, including providing private, yet extensive collaborative filtering. Accordingly, the above and other needs are addressed by the illustrative embodiments of the present invention, which provide a novel method and system for private, distributed collaborative filtering, and the like. Accordingly, in illustrative embodiments, there are provided system and methods for private distributed collaborative filtering, wherein part of the collaborative filtering is done in a client device, where a private profile is kept securely, and the like. Then, a local shielding process calculates a set of non-private parameters, and the like, that are requested and communicated to a server and/or other client devices over a wired or wireless communications network. The non-private parameters are generated through the shielding process running inside the client device. Then, the server or other client devices can improve internal collaborative processing using such non-private parameters. Advantageously, the overall results of such a private distributed collaborative filtering process can reach the accuracy of conventional, non-private collaborative filtering processes, and the like.

Accordingly, in an illustrative aspect, there is provided a system, method and computer program product for private collaborative filtering including a client device configured with a distributed internal collaborative filtering mechanism and a user profile having private information of a user of the client device. The client device is configured to maintain the user profile securely within the client device. The client device is configured to calculate a set of non-private parameters based on the secure user profile with a process that runs on the client device. The client device is configured to send the non-private parameters to at least one of an external server and external client device.

The client device is configured to run the process that calculates the set of non-private parameters as a shielding process running within the client device.

The client device is configured to send the non-private parameters to the external server or the external client device over a wired or wireless communications network.

The external server or the external client device is configured to update collaborating filtering mechanisms on the external server or the external client device based on the received non-private parameters.

Still other aspects, features, and advantages of the present invention are readily apparent from the following detailed description, simply by illustrating a number of illustrative embodiments and implementations, including the best mode contemplated for carrying out the present invention. The present invention also is capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings, in which like reference numerals refer to similar elements, and in which:

FIG. 1 is an illustrative input to a collaborative filtering system and method;

FIG. 2 is an illustrative collaborative filtering process;

FIG. 3 is an illustrative user signature;

FIG. 4 are illustrative steps for building a collaborative filtering model for the users;

FIG. 5 are illustrative steps for forecasting user preferences from an incomplete profile;

FIG. 6 is an illustrative local collaborative filtering model generation between a user and friends of the user;

FIG. 7 is an illustrative periodic updating process in a server based on a local collaborative filtering model and confidence received from users;

FIG. 8 is an illustrative system for private distributed collaborative filtering based on FIGS. 1-7; and

FIG. 9 is an illustrative method for private distributed collaborative filtering based on FIGS. 1-8.

### DETAILED DESCRIPTION OF THE PREFERRED EMBODIMENTS

The present invention includes recognition that personalization of various Internet services has become a crucial value to consumers and one of the main drivers for higher revenue for Internet companies, and the like. For example, progress has been made by employing collaborative filtering, for example, using a history of Internet browsing, and other activities, such as game, chat, emails, etc, to determine needs, wants, and the like, of a targeted consumer. Such information can be used to produce personalized advertisement, or in a more general setting to provide personalized recommendations, and the like. The recommendation systems can be used to provide content, products, services, and the like.

Thus, such recommendation systems can employ machine learning, and the like, referred to as collaborative filtering. Collaborative filtering can include methods for making automatic predictions (e.g., filtering) about interests of a user by collecting preferences or taste information, and the like, from many users (e.g., collaborating). The underlying assumption of such a collaborative filtering approach is that those who have agreed in the past tend to agree again in the future. For example, a collaborative filtering or recommendation system for books could make predictions about which book a user may like given a partial list of that user's tastes (e.g., likes or dislikes), based on processing likes and dislikes of other users with similar tastes. Collaborative approaches focus on the output (e.g., items purchased by the user), rather than focusing on the underlying model (e.g., the interest of the user). Such an approach has been advantageous in predicting user interests, behaviors, and the like.

In such a collaborative filtering systems and methods, private data about user, such as a user profile, is gathered on a server for processing. Such processing compromises the privacy of the user profile and takes the profile out of the user control and into the server control. Under current practices, users have been mostly complacent with loosing control over their profile information, because (i) Internet companies have devised various security policies, and the like, in an attempt to keep such private profiles safe and for limited time on their servers, and (ii) the benefits of the use of such information may be seen as justifying the loss of privacy control.

However, recently there have been increasing concerns from users and user advocates about such compromised user privacy. For example, in many Europe countries there are strong laws protecting privacy of users and that limits the abilities of Internet companies to get a most effective outcome from analyzing such private profile information. Even in the US, many user advocate groups are starting to raise class action law suits based on compromised user privacy. Advantageously, the present systems and methods provide effective collaborative filtering, aggregate machine learning processes, and the like, while maintaining the privacy for user profile information, and the like.

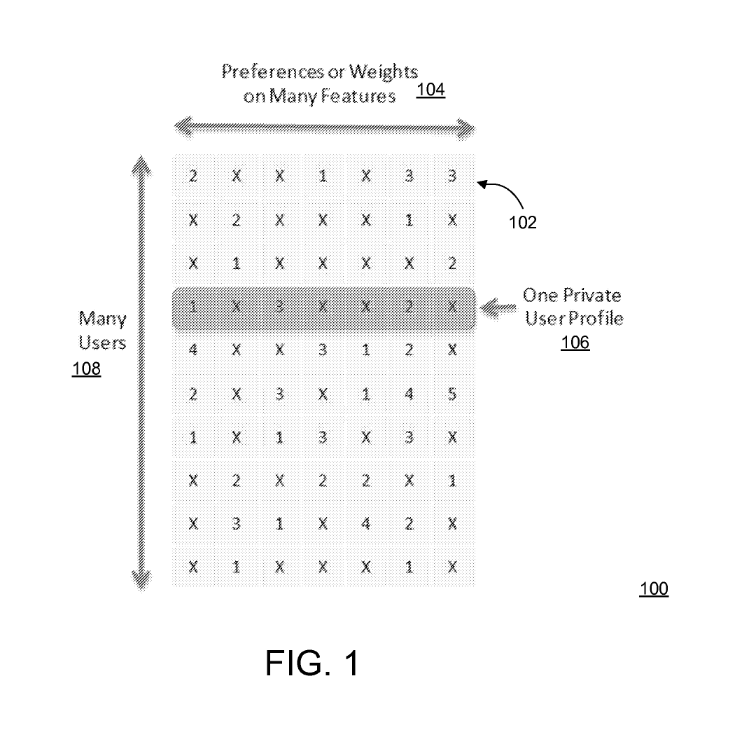

Referring now to the drawings, in FIG. 1 there is shown an illustrative input to a collaborative filtering system and method. In FIG. 1, a set of features 102 is chosen. These features 102 can be direct items like movies that a user watches, or the web links that a user clicks, and the like. Such features can include basic demographics, such as age, sex, income level, etc. Each row 104 of such a table 100 is a private user profile 106 of one user of many users 108. Values for a feature for a user can be an order of preference (e.g., as shown in the FIG. 1) or a weight showing how strong a feature exists for that user, or just a general value for the feature, and the like.

The above table 100 may be highly sparse, for example, there may be many missing data items meaning that either the user has not been given the chance to choose that feature or the user preference or weight on that feature is not known. An advantageous goal of collaborative filtering is to predict the values for the missing data points.

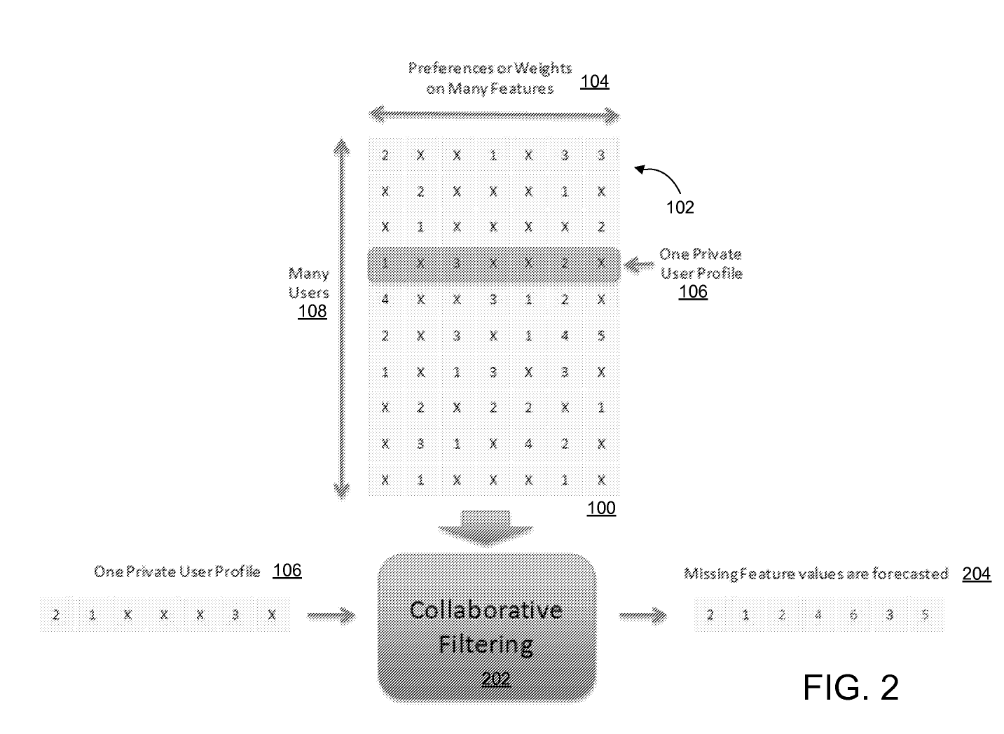

The typical output of a collaborative filtering process is shown in FIG. 2. In FIG. 2, given the user profile 106 with some known features, collaborative filtering 202 forecasts at 204 an interest rank or weight for the same user 106 on the other missing items. In many cases, the number of features 102 can be quiet large, which makes it impractical to work with a highly parsed input table 100. Some of the most practical collaborative filtering processes 202 work based on lower number of features 102 that can be latent and be calculated from mining many items to show the underlying advantageous factors. For example, instead of considering individual movies, clusters of movies seen together can be mined and considered as a feature that relates to the underlying similarities between such clustered movies (e.g., action movies with sad endings).

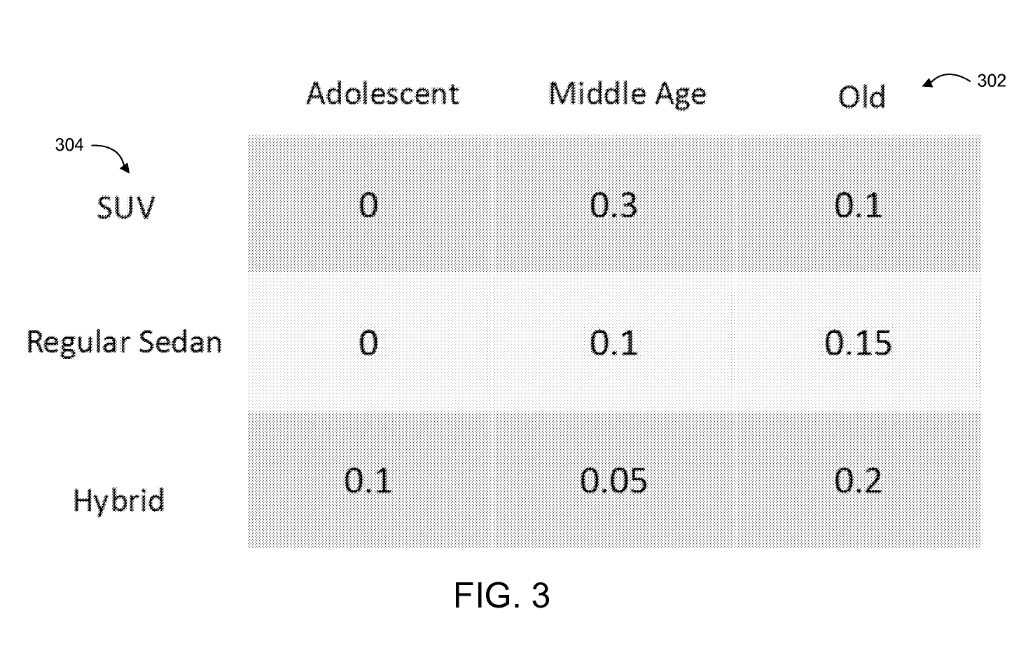

Finally, to build a model for the users there are many machine learning algorithms that cluster users and provide a signature to measure similarity of the users. For example, consider the households in US. For each household one can keep records or a set of features. On the other hand, to build a model for a household, one may find out a strong signature is a combination of the people in various ages in the household and their car preferences. An example signature for this example is shown in a table FIG. 3, where the table shows how much one family correlates along the nine categories, where family members in various age groups in the household are shown along the x axis 302, and their car preferences are shown along the y axis 304, and wherein the higher the number, the higher the correlation.

Building a user model out of collaborative filtering is very useful since such model can provide systematic way for employing collaborative filtering in several stages, as follows:

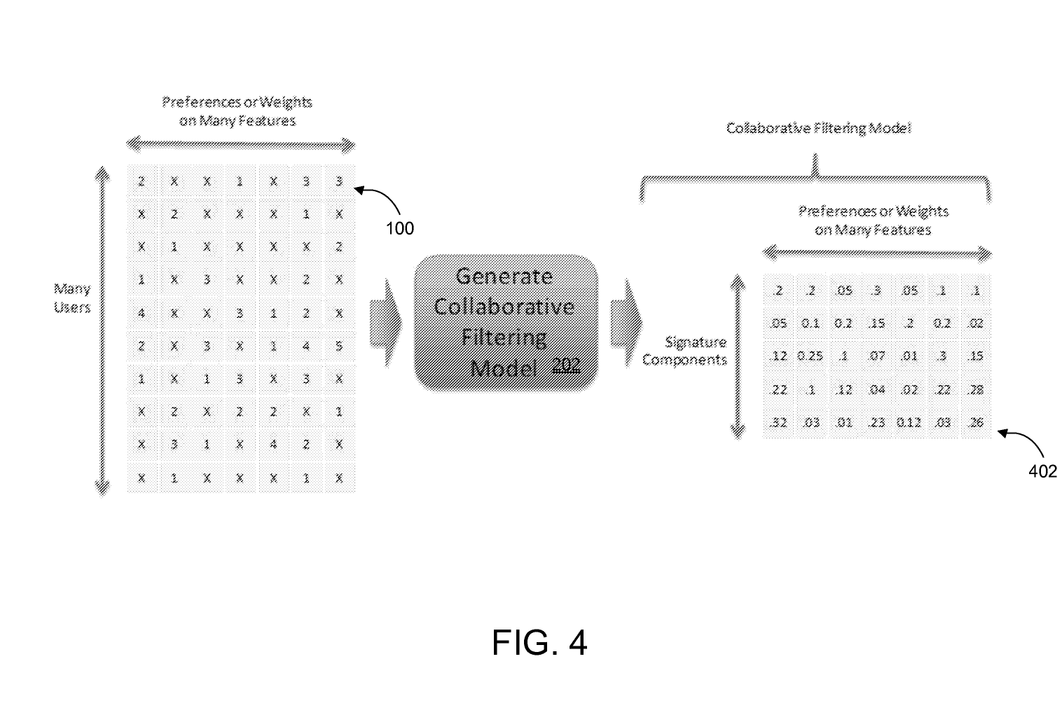

Step 1: As shown in FIG. 4, based on all users from in the input table 100 of FIG. 1, a signature 402 is calculated.

Step 2: As shown in FIG. 4, based on a collaborative filtering modeling procedure 202, the signature table 402 is generated, and which provides for each component of the signature how much interest there is in a given feature, wherein the higher the number, the higher the interest. Such model based on all of the users does not include private user data and is an aggregated and generated from the total user population.

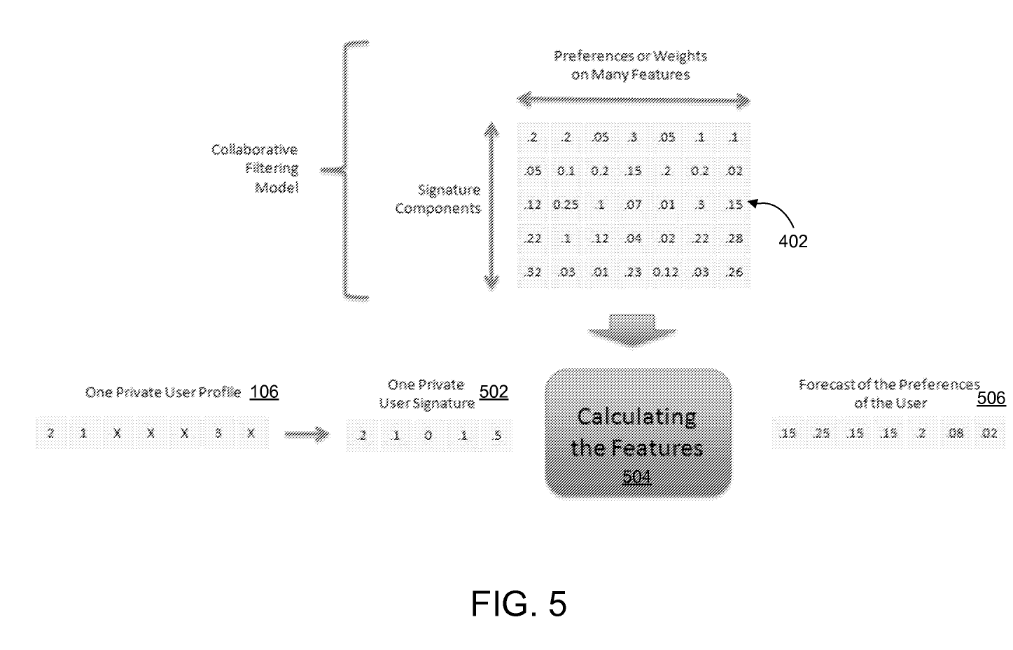

Step 3: As shown in FIG. 5, the private profile 106 for a specific user is provided, and a signature 502 for the user is calculated.

Step 4: As shown in FIG. 5, using the signature 502 of the user and the user model table 402 from step 2, interest of 506 the user regarding the other missing features can calculated and forecast at 504.

However, a problem in the above processing is the sending of the private profile 106 of the user to the server in steps 1 and 2, which compromises the privacy of the user profile. Advantageously, the illustrative systems and methods address this and other problems, by performing the steps 1 to 4 in a distributed fashion among client devices from which users access the Internet and the server, and without compromising the private user profile information.

Accordingly, in an illustrative embodiment, the illustrative systems and methods calculate the collaborative filtering model 202 in FIG. 4 in a distributed and iterative fashion among the client devices. Advantageously, each of the client devices provides a small non-private piece of a new information to make the main model 202 more accurate, and need only sends such new information about the model to the server (or e.g., other peers). Thus, the illustrative systems and methods need not send private user profile information 106 or a private user signature 502 outside the client device.

The update process of the model 202 is handled by sending the delta of the new information that is locally calculated about the model on the client device. This means that some of the elements of the collaborative filtering model 202 are calculated internally in the client device. For each local model element, a level of confidence measure is also provided. Advantageously, when the server (or e.g., the other peers) receives such information, the server understands the level of confidence for each element for guiding adjustments in the existing model 202 to update same.

To ensure the delta sent from the client to the server (or e.g., the other peers) does not have residuals about the private profile 106 and signature 502, the illustrative systems and methods use known techniques to “shield” the private profile 106 and signature 502. Such shielding is based on making the client become a small server that does collaborative filtering between a small set of its own user data and user data of friends, and the like. This is possible because the local collaborative filtering algorithm in the client, which with the suitable permissions, can have access to information about the friends of the user. Examples of this include social networking site profile of friends, emails of the friends, texts, and messaging of the friends, and the like.

Accordingly, the illustrative systems and methods perform the following steps:

Step 1: Transfer: Client device receives the latest user profile 106 from the server. This does not need to happen too fast. Updates can be much slower than speed in which models are used for calculating local results in the client devices.

Step 2: In the Client Device: Client device calculates the private signature 502 based on the private data 106 and the collaborative filtering model. Advantageously, in calculating the signature 502, the private profile 106 need not be sent to the server.

Step 3: In the Client Device: The weights 506 for the missing features for the user are calculated locally using the collaborative filtering model 504 and the local user signature 502. Steps 2 and 3 can be similar to the steps shown in FIG. 5, except for being performed in the client device.

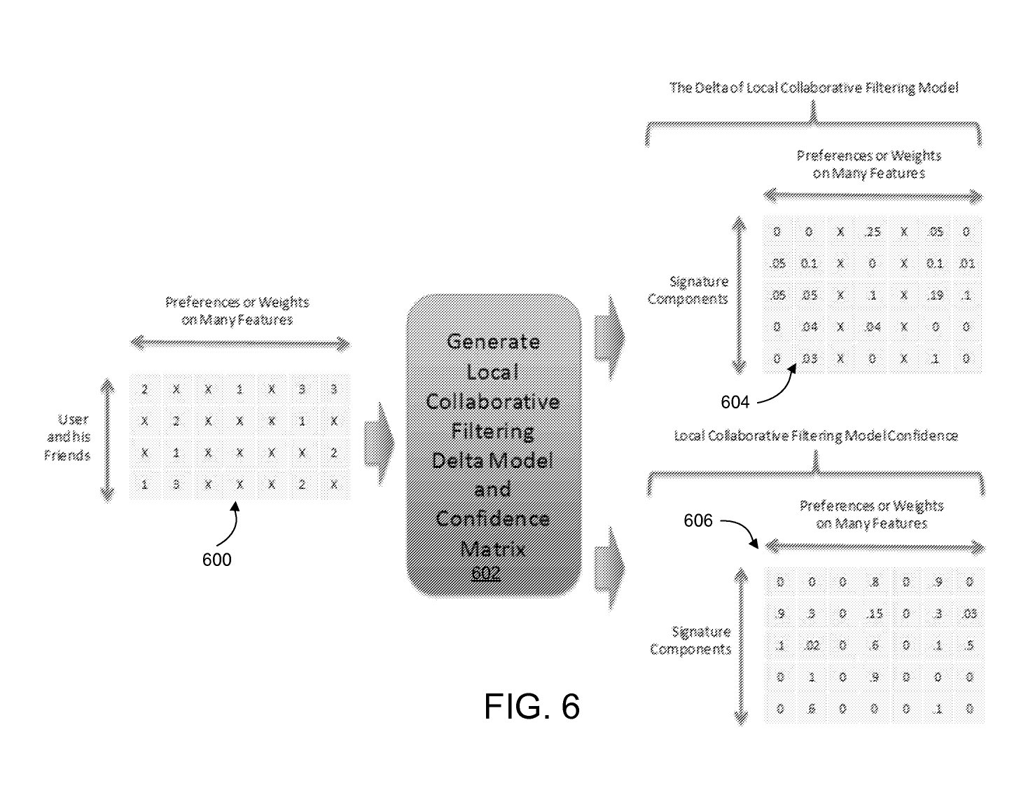

Step 4: In the Client Device: As shown in FIG. 6, the client device runs a limited collaborative filtering 602 between itself and profiles of friends 600 to which the client device has access. The result of such collaborative filtering 602 provides a delta 604 to the base collaborative filtering model 602 that has been last sent to the client device. Moreover, a measure of confidence 606 is provided for the delta 604 for each element in the collaborative filtering model 602. The level of confidence 606 depends on the strength of the evidence in the private profile of the user and friends of the user 600.

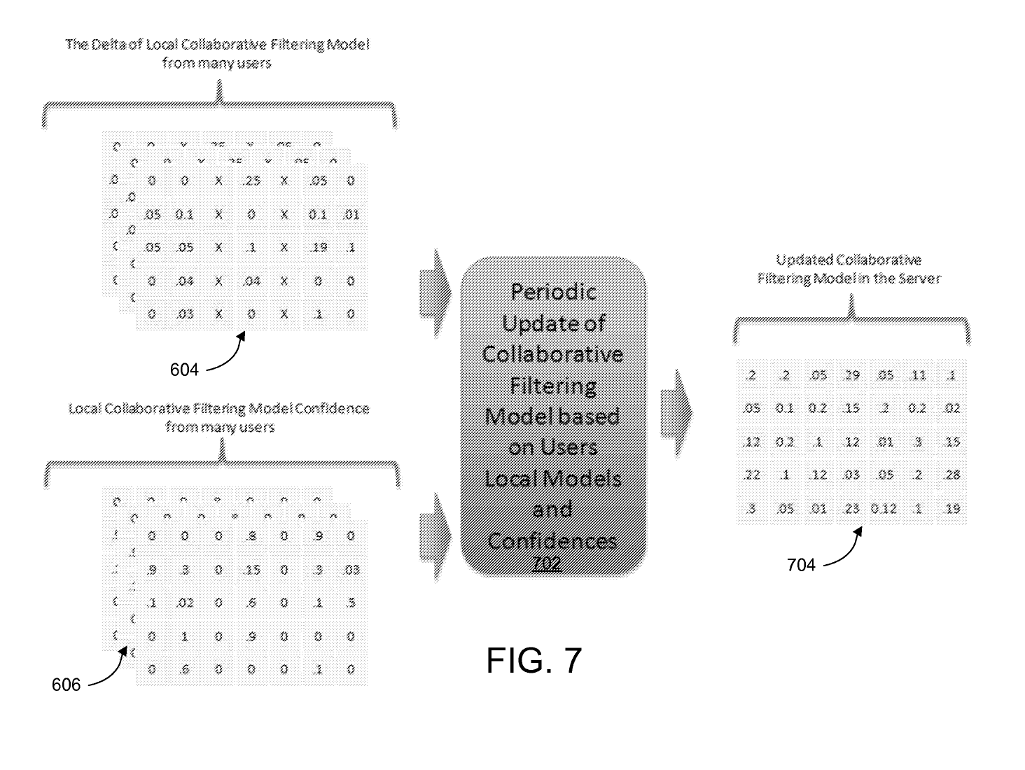

Step 5: Transfer: As shown in FIG. 7, at the frequency lower than the frequency of local updates, the delta 604 and the confidence measure 606 is sent to the server. Advantageously, no private data is transferred to the server (or e.g., other peers).

Step 6: In the Server: As shown in FIG. 7, the server at 702 updates the current collaborative filtering model 704 periodically based on the delta 604 and the confidence measures 606 received from the client devices.

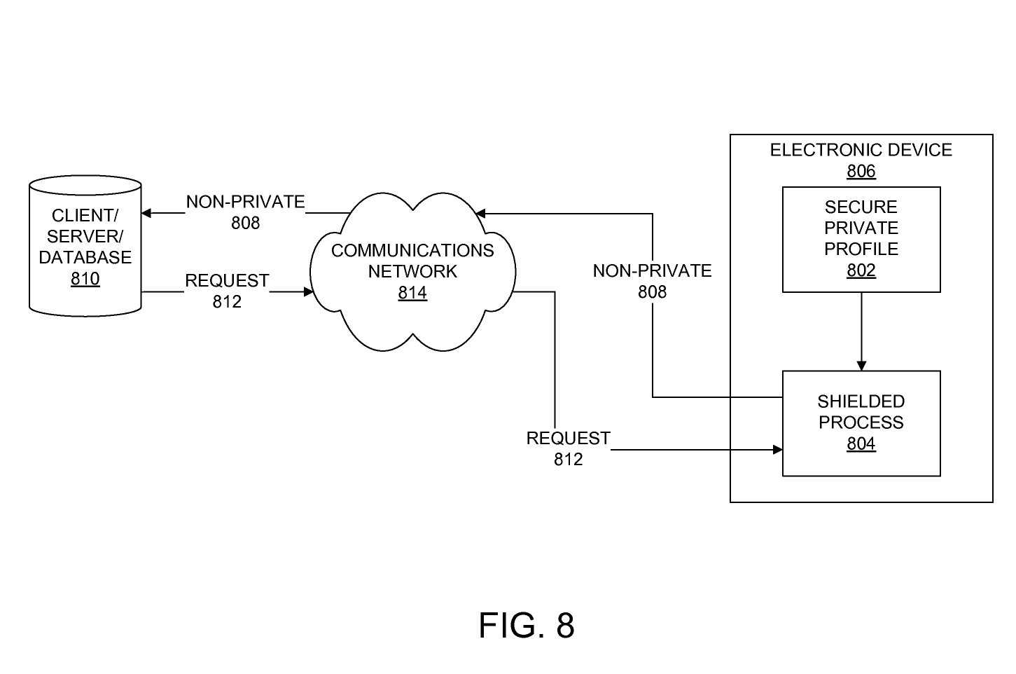

FIG. 8 is an illustrative system for private distributed collaborative filtering based on FIGS. 1-7. In FIG. 8, part of the collaborative filtering is done in a client device 806, where a private profile 802 is kept securely, and the like. Then, a local shielding process 804 calculates a set of non-private parameters 808, and the like, that are requested at 812 and communicated to a server and/or other client devices 810 over a wired or wireless communications network 814. The non-private parameters 808 are generated through the shielding process 804 running inside the client device 806. Then, the server or other client devices 810 can improve internal collaborative processing using such non-private parameters 808. Advantageously, the overall results of such a private collaborative filtering process can reach the accuracy of conventional, non-private collaborative filtering processes, and the like.

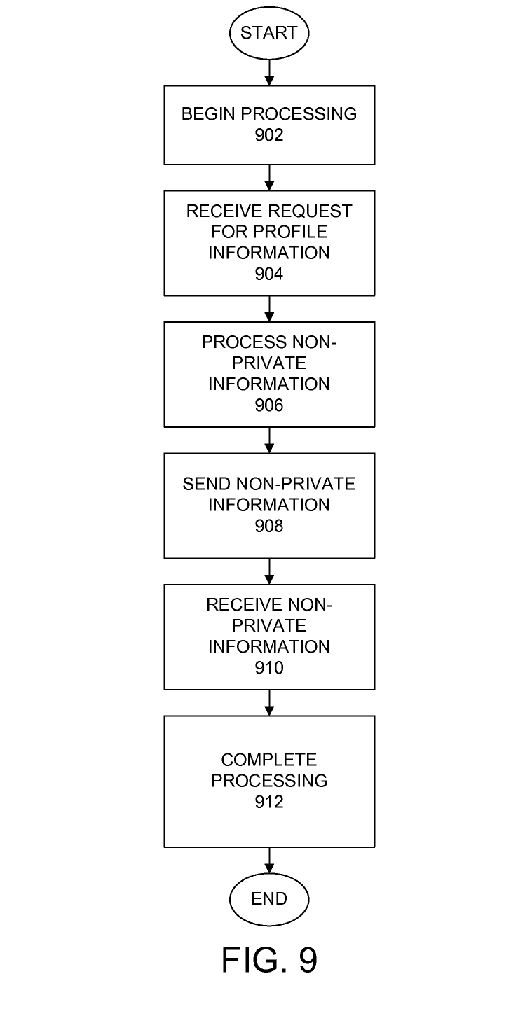

FIG. 9 is an illustrative method for private distributed collaborative filtering based on FIGS. 1-8. In FIG. 9, at step 902 processing begins. At step 904, the client device receives the request for profile information. At step 906, the client device processes the non-private information 808. At step 908, the client device sends the non-private information 808 to the server and/or other client devices 810. At step 910, the server and/or other client devices 810 receives the non-private information 808 to update its collaborative filtering model 704, completing the processing at step 912.

The above-described devices and subsystems of the illustrative embodiments of FIGS. 1-9 can include, for example, any suitable servers, workstations, PCs, laptop computers, PDAs, Internet appliances, handheld devices, cellular telephones, wireless devices, other electronic devices, and the like, capable of performing the processes of the illustrative embodiments of FIGS. 1-9. The devices and subsystems of the illustrative embodiments of FIGS. 1-9 can communicate with each other using any suitable protocol and can be implemented using one or more programmed computer systems or devices.

One or more interface mechanisms can be used with the illustrative embodiments of FIGS. 1-9, including, for example, Internet access, telecommunications in any suitable form (e.g., voice, modem, and the like), wireless communications media, and the like. For example, employed communications networks or links can include one or more wireless communications networks, cellular communications networks, cable communications networks, satellite communications networks, G3 communications networks, Public Switched Telephone Network (PSTNs), Packet Data Networks (PDNs), the Internet, intranets, WiMax Networks, a combination thereof, and the like.

It is to be understood that the devices and subsystems of the illustrative embodiments of FIGS. 1-9 are for illustrative purposes, as many variations of the specific hardware and/or software used to implement the illustrative embodiments are possible, as will be appreciated by those skilled in the relevant art(s). For example, the functionality of one or more of the devices and subsystems of the illustrative embodiments of FIGS. 1-9 can be implemented via one or more programmed computer systems or devices.

To implement such variations as well as other variations, a single computer system can be programmed to perform the special purpose functions of one or more of the devices and subsystems of the illustrative embodiments of FIGS. 1-9. On the other hand, two or more programmed computer systems or devices can be substituted for any one of the devices and subsystems of the illustrative embodiments of FIGS. 1-9. Accordingly, principles and advantages of distributed processing, such as redundancy, replication, and the like, also can be implemented, as desired, to increase the robustness and performance the devices and subsystems of the illustrative embodiments of FIGS. 1-9.

The devices and subsystems of the illustrative embodiments of FIGS. 1-9 can store information relating to various processes described herein. This information can be stored in one or more memories, such as a hard disk, optical disk, magneto-optical disk, RAM, and the like, of the devices and subsystems of the illustrative embodiments of FIGS. 1-9. One or more databases of the devices and subsystems of the illustrative embodiments of

FIGS. 1-9 can store the information used to implement the illustrative embodiments of the present invention. The databases can be organized using data structures (e.g., records, tables, arrays, fields, graphs, trees, lists, and the like) included in one or more memories or storage devices listed herein. The processes described with respect to the illustrative embodiments of FIGS. 1-9 can include appropriate data structures for storing data collected and/or generated by the processes of the devices and subsystems of the illustrative embodiments of FIGS. 1-9 in one or more databases thereof.

All or a portion of the devices and subsystems of the illustrative embodiments of FIGS. 1-9 can be conveniently implemented using one or more general purpose computer systems, microprocessors, digital signal processors, micro-controllers, application processors, domain specific processors, application specific signal processors, and the like, programmed according to the teachings of the illustrative embodiments of the present invention, as will be appreciated by those skilled in the computer and software arts. Appropriate software can be readily prepared by programmers of ordinary skill based on the teachings of the illustrative embodiments, as will be appreciated by those skilled in the software art. In addition, the devices and subsystems of the illustrative embodiments of FIGS. 1-9 can be implemented by the preparation of application-specific integrated circuits or by interconnecting an appropriate network of conventional component circuits, as will be appreciated by those skilled in the electrical art(s). Thus, the illustrative embodiments are not limited to any specific combination of hardware circuitry and/or software.

Stored on any one or on a combination of computer readable media, the illustrative embodiments of the present invention can include software for controlling the devices and subsystems of the illustrative embodiments of FIGS. 1-9, for driving the devices and subsystems of the illustrative embodiments of FIGS. 1-9, for enabling the devices and subsystems of the illustrative embodiments of FIGS. 1-9 to interact with a human user, and the like. Such software can include, but is not limited to, device drivers, firmware, operating systems, development tools, applications software, and the like. Such computer readable media further can include the computer program product of an embodiment of the present invention for performing all or a portion (if processing is distributed) of the processing performed in implementing the illustrative embodiments of FIGS. 1-9. Computer code devices of the illustrative embodiments of the present invention can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the illustrative embodiments of the present invention can be distributed for better performance, reliability, cost, and the like.

As stated above, the devices and subsystems of the illustrative embodiments of FIGS. 1-9 can include computer readable medium or memories for holding instructions programmed according to the teachings of the present invention and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave, or any other suitable medium from which a computer can read.

While the present invention have been described in connection with a number of illustrative embodiments and implementations, the present invention is not so limited, but rather covers various modifications and equivalent arrangements, which fall within the purview of the appended claims.

What is claimed is:

1. A system for collaborative filtering, the system comprising:
a client device configured with a distributed internal collaborative filtering mechanism and a user profile having private information of a user of the client device,
wherein the client device is configured to maintain the user profile securely within the client device;
the client device is configured to calculate a set of non-private parameters based on the secure user profile with a process that runs on the client device; and
the client device is configured to send the non-private parameters to at least one of an external server and external client device.

2. The system of claim 1, wherein the client device is configured to run the process that calculates the set of non-private parameters as a shielding process running within the client device.

3. The system of claim 1, wherein the client device is configured to send the non-private parameters to the external server or the external client device over a wired or wireless communications network.

4. The system of claim 1, wherein the external server or the external client device is configured to update collaborating filtering mechanisms on the external server or the external client device based on the received non-private parameters.

5. A method for collaborative filtering, the method comprising:
including in a client device a distributed internal collaborative filtering mechanism and a user profile having private information of a user of the client device;
maintaining with the client device the user profile securely within the client device;
calculating a set of non-private parameters based on the secure user profile with a process running on the client device; and
sending with the client device the non-private parameters to at least one of an external server and external client device.

6. The method of claim 5, further comprising the client device running the process that calculates the set of non-private parameters as a shielding process running within the client device.

7. The method of claim 5, further comprising sending with the client device the non-private parameters to the external server or the external client device over a wired or wireless communications network.

8. The method of claim 5, further comprising updating collaborating filtering mechanisms on the external server or the external client device based on the received non-private parameters.

9. A computer program product for collaborative filtering, and including one or more computer readable instructions embedded on a non-transitory, tangible computer readable medium and configured to cause one or more computer processors to perform the steps of:
including in a client device a distributed internal collaborative filtering mechanism and a user profile having private information of a user of the client device;
maintaining with the client device the user profile securely within the client device;
calculating a set of non-private parameters based on the secure user profile with a process running on the client device; and
sending with the client device the non-private parameters to at least one of an external server and external client device.

10. The computer program product of claim 9, further comprising the client device running the process that calculates the set of non-private parameters as a shielding process running within the client device.

11. The computer program product of claim 9, further comprising sending with the client device the non-private parameters to the external server or the external client device over a wired or wireless communications network.

12. The computer program product of claim 9, further comprising updating collaborating filtering mechanisms on the external server or the external client device based on the received non-private parameters.
